(19) United States
(12) Patent Application Publication
(10) Pub. No.: US 2008/0257189 A1
(43) Pub. Date: Oct. 23, 2008

(54) METHOD FOR OPERATING AN INKING SYSTEM OF A PRINTING PRESS

(75) Inventors: Norbert Dylla, Stadtbergen (DE); Roland Hirt, Friedberg (DE); Thomas John, Augsburg (DE); Rudolf Naegele, Friedberg (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/875,719

(22) Filed: Oct. 19, 2007

(30) Foreign Application Priority Data
Oct. 20, 2006 (DE) 10 2006 049 619.1

(51) Int. Cl. B41F 33/00

(52) U.S. Cl. 101/483

(57) ABSTRACT

A method for operating an inking system of a printing press, where the inking system has an ink fountain in which printing ink is kept in readiness, where the inking system has a doctor roller which holds printing ink kept in readiness in the ink fountain, where the inking system has ink sliders or ink blades which adjust the amount of ink to be transferred per ink zone from the ink fountain to the doctor roller, and where the inking system has a film roller which transfers printing ink from the doctor roller to at least one inking system roller downstream from the film roller. At least one ink slider or ink blade is controlled in such a way that the amount of ink transferred zonally to the doctor roller varies over the circumference of the doctor roller.

This application claims the priority of German Patent Document No. 10 2006 049 619.1, filed Oct. 20, 2006, the disclosure of which is expressly incorporated by reference herein.

### BACKGROUND AND SUMMARY OF THE INVENTION

The present invention relates to a method for operating an inking system of a printing press.

Inking systems of printers have an ink fountain in which printing ink is kept in readiness; the printing ink that is kept in readiness in the ink fountain is scooped out of the ink fountain by a doctor roller. The amount of ink required for a print substrate may vary zonally, which is why the amount of ink to be transferred out of the ink fountain onto the doctor roller per ink zone is adjustable via so-called ink sliders or ink blades. A film roller or a siphon roller is arranged downstream from the doctor roller, removing the printing ink from the doctor roller and transferring it to at least one of the inking system rollers downstream from the film roller or siphon roller. The printing ink ultimately goes to a printing plate on a plate cylinder via the/each inking system roller downstream from the film roller or siphon roller.

With inking systems that have a film roller downstream from the doctor roller, the transfer of ink from the doctor roller to the film roller is problematical when small quantities of ink are needed and thus the ink layer thickness on the doctor roller corresponds approximately to the gap width of the gap between the doctor roller and the film roller. If the ink layer thickness turns out to be somewhat too small, it may lead to an interruption in the ink transfer between the doctor roller and the film roller; if the ink layer thickness is too great, this results in a percentage change in the quantity of ink on the print substrate in the two-digit percentage range. Accurate metering of the amount of ink is thus difficult with inking systems using film rollers under the operating condition that the ink layer thickness on the doctor roller corresponds approximately to the gap width of the gap between the doctor roller and the film roller.

In the case of an inking system in which the doctor roller is downstream from a siphon roller, accurate metering of ink is possible in this regard, but the oscillating motion of the siphon roller leads to vibration of the printer, which is unacceptable in the case of high-speed web-fed printing presses in particular. Therefore, inking systems with film rollers are used with web-fed printing presses.

Against this background, the present invention is based on the problem of creating a novel inking system for a printing press using a film roller such that the system allows accurate metering of the amount of ink under all operating conditions. According to the invention, at least one ink slider or ink blade is controlled in such a way that the amount of ink transferred to the doctor roller zonally is varied over the circumference of the doctor roller.

The present invention provides an inking system having a print roller and a film roller in which ink sliders or ink blades of the inking system are controlled in such a way that the amount of ink transferred to the doctor roller varies over the circumference of the doctor roller. The amount of ink applied to the doctor roller per revolution is obtained from the average amount of ink, which varies over the circumference of the doctor roller. This permits a highly accurate metering of the amount of ink with film inking systems.

According to an advantageous embodiment of the present invention, the ink sliders and/or ink blades are controlled in such a way that, depending on the desired zonal area coverage or ink layer thickness, a frequency and/or an amplitude of the zonal ink quantity transferred to the doctor roller and/or zonal change in the gap between the doctor roller and the ink sliders and/or ink blades is/are adjusted.

Preferred embodiments of the invention are derived from the following description. Exemplary embodiments of the invention are explained in greater detail below, without being limited to these embodiments, on the basis of the drawings.

### BRIEF DESCRIPTION OF THE DRAWINGS

FIG. 1 shows a schematic view of a printing unit;

FIG. 2 shows a detail of the printing unit of FIG. 1 in the area of an inking system; and

FIG. 3 shows the detail from FIG. 2 to illustrate the inventive method.

### DETAILED DESCRIPTION OF THE DRAWINGS

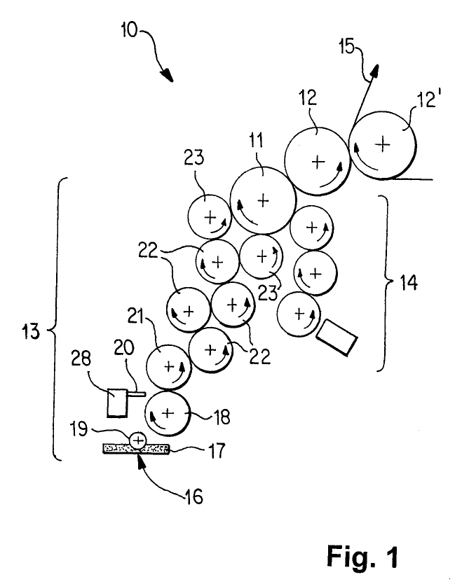

The present invention is explained in greater detail below with reference to FIGS. 1 through 3.

FIG. 1 shows a schematic view of a printing unit 10 of a web-fed printing press, where the printing unit 10 comprises a plate cylinder 11, a transfer cylinder 12, an inking system 13 and a dampening system 14. With the help of the inking system 13, printing ink is applied to at least one printing plate positioned on the plate cylinder 11, but with the help of the dampening system 14, dampening agent can be applied to the/each printing plate. The printing ink applied to the plate cylinder 11 is transferred to a print substrate 15 with the help of the transfer cylinder 12, whereby according to FIG. 1, the transfer cylinder 12′ of another printing unit rolls over the transfer cylinder 12 of the printing unit 10.

The inking system 13 of the print mechanism 10 has an ink fountain 16, in which printing ink 17 is kept in readiness. A doctor roller 18 scoops printing ink 17 out of the inking system 13 with the intermediate arrangement of an immersion roller 19, whereby the amount of ink transferred per ink zone out of the ink fountain 16 onto the doctor roller 18 is adjusted via the ink sliders and/or ink blades 20.

A film roller 21, which is operated at a relatively high rotational speed, is downstream from the doctor roller 18, which is operated at a relatively low rotational speed, the printing ink being transferred from the doctor roller 18 via the film roller 21 to the inking system rollers 22 and/or 23 downstream from the film roller 21. The inking system rollers 23 roll over the plate cylinder 11 and are also known as ink applicator rollers.

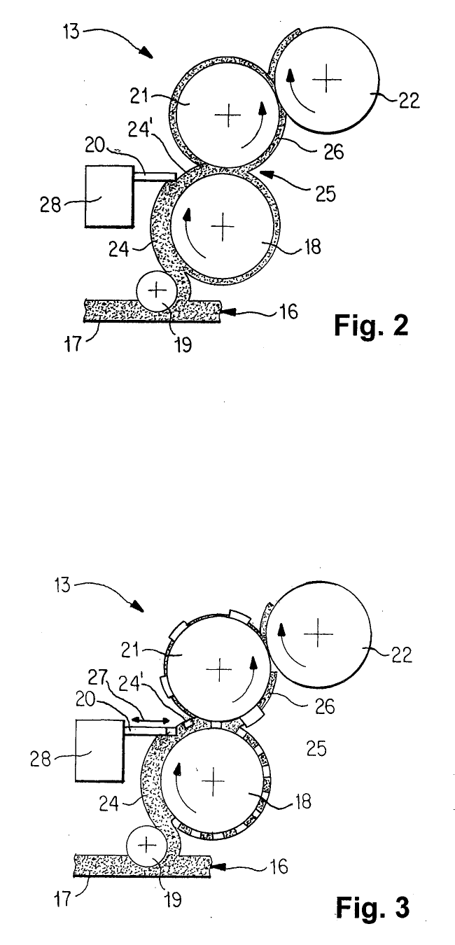

FIG. 2 illustrates the interaction of the doctor roller 18, the ink blades 20 and the film roller 21 in the transfer of printing ink from the ink fountain 16 to an inking system 22, where the doctor roller 18, with the intermediate arrangement of the immersion roller 19, scoops printing ink 17 out of the inking system 16, thereby forming an ink film 24. The zonal thickness of the ink film 24 on the doctor roller 18 is adjusted by means of the ink blade 20, whereby the ink film on the doctor roller 18 downstream from the ink blade 20 is labeled with reference numeral 24′ in FIG. 2. According to FIG. 2, a gap 25 is formed between the doctor roller 18 and the film roller 21. Depending on the thickness of the ink film 24′ on the doctor roller 18 and on the width of the gap 25 between the doctor roller 18 and the film roller 21, an ink film 26 develops on the film roller 21. With such film inking systems, the position of the ink blade and/or ink slider 20 during printing is constant according to the state of the art, but the transfer of printing ink from the doctor roller 18 to the film roller 21 poses problems when the thickness of the ink film 24′ on the doctor roller 18 corresponds approximately to the width of the gap 25 between the doctor roller 18 and the film roller 21.

To take this problem into account, a film inking system is operated in the sense of the present invention (see FIG. 3) so that at least one ink slider and/or ink blade 20 of the inking system 13 is controlled in such a way that the amount of ink to be transferred to the doctor roller 18 and thus the thickness of the ink film 24′ on the doctor roller 18 changes in at least one ink zone over the circumference of the doctor roller 18.

To do so, the ink blades 20 are constantly moved back and forth in the direction of the double arrow 27 according to FIG. 3. The position of the ink blades 20 is therefore not constant and instead changes during printing.

The back-and-forth movement of the ink blades 20 of the inking system 13 as mentioned above is performed in particular when small quantities of ink are to be applied to the doctor roller 18 and to the film roller 21. The thickness of the ink layer 24′ on the doctor roller 18, which develops downstream from the ink blades 20 and upstream from the gap 25, is preferably alternately smaller and larger than the dimension of the gap 25. However, the ink blades 20 may also be controlled in such a way that the thickness of the ink film 24′ on the doctor roller 18 is always greater than the width 25 between the doctor roller 18 and the film roller 21.

Thus in the sense of the present invention, the ink blades 20 of the inking system 13 are controlled in such a way that a zonal gap width of the gap between the doctor roller 18 and the ink blades 20 is constantly varied to provide a varying thickness of the ink film 24′ over the circumference of the doctor roller 18. The amount of ink applied per ink zone to the doctor roller 18 is obtained from the average of the respective zonal amount of ink over the relevant, i.e., effective, circumference of the doctor roller 18.

The ink blades 20 are controlled so that the frequency and/or amplitude of the amount of ink transferred zonally to the doctor roller and/or a zonal change in the gap between the doctor roller 18 and the ink blades 20 is adjusted, depending on the desired ink layer thickness and/or the desired zonal coverage. It is possible here to adapt either exclusively the frequency or exclusively the amplitude of the change in the ink layer thickness of the ink film 24′ and/or the change in the gap between the doctor roller and the ink blades 20. In addition, it is also possible to change the frequency and amplitude jointly.

In particular, electromechanical drives, electric motors, e.g., linear motors or stepping motors, electromagnetic drives and pneumatic or hydraulic actuator devices may be used as the drives 28 for adjusting the ink blades 20 in the sense of the present invention.

### LIST OF REFERENCE NUMERALS

10 Printing unit
11 Plate cylinder
12, 12′ Transfer cylinder
13 Inking system
14 Dampening system
15 Print substrate
16 Ink fountain
17 Printing ink
18 Doctor roller
19 Immersion roller
20 Ink blade
21 Film roller
22 Inking system roller
23 Inking system roller
24, 24′ Ink film
25 Gap
26 Ink film
27 Direction of movement
28 Drive

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for operating an inking system on a printing press, wherein the inking system has an ink fountain in which printing ink is kept in readiness, wherein the inking system has a doctor roller which holds printing ink kept on supply in the ink fountain, wherein the inking system has ink sliders or ink blades by means of which an amount of ink transferred from the ink fountain to the doctor roller per ink zone is adjusted, and wherein the inking system has a film roller by means of which printing ink is transferred from the doctor roller to an inking system roller downstream from the film roller, wherein at least one ink slider or ink blade is controlled in such a way that the amount of ink transferred zonally to the doctor roller is varied over a circumference of the doctor roller.

2. The method according to claim 1, wherein the at least one ink slider or ink blade is controlled in such a way that a zonal gap width of a gap between the doctor roller and the at least one ink slider or ink blade is varied constantly.

3. The method according to claim 1, wherein the at least one ink slider or ink blade is controlled in such a way that a frequency and/or an amplitude of a zonal transfer of ink quantity to the doctor roller and/or a zonal change in a gap between the doctor roller and the at least one ink slider or ink blade is/are adjusted as a function of a desired zonal coverage or ink layer thickness.

4. A method for operating an inking system of a printing press, comprising the steps of:
applying ink to a doctor roller of the printing press;
moving an ink blade during a printing operation of the printing press; and
varying an amount of ink remaining around a circumferential length of the doctor roller in an ink zone by the step of moving the ink blade.

5. The method according to claim 4, wherein the step of moving the ink blade adjusts a width of a gap between the doctor roller and the ink blade.

6. The method according to claim 4, wherein the amount of ink remaining around the circumferential length of the doctor roller varies between a first amount greater than a width of a gap between the doctor roller and a film roller and a second amount less than the width of the gap between the doctor roller and the film roller.

7. The method according to claim 4, wherein the amount of ink remaining around the circumferential length of the doctor roller is always greater than a width of a gap between the doctor roller and a film roller.

8. The method according to claim 4, wherein the amount of ink remaining around the circumferential length varies between ink zones defined on the doctor roller.

9. The method according to claim 4, wherein the step of moving the ink blade during the printing operation of the printing press changes a position of the ink blade relative to the doctor roller.

10. The method according to claim 4, wherein the step of moving the ink blade during the printing operation of the printing press moves the ink blade during a revolution of the doctor roller.
